(19) United States
(12) Patent Application Publication
(10) Pub. No.: US 2018/0133598 A1
(43) Pub. Date: May 17, 2018

(54) Multi-player Computer Game Apparatus with a Game Information Display

(71) Applicant: Sega Amusements International Ltd., Chessington (GB)

(72) Inventors: Matthew Page, Cardiff (GB); Shinichi Ogasawara, Cardiff (GB); Patrick Michael, Cardiff (GB)

(21) Appl. No.: 15/351,281

(22) Filed: Nov. 14, 2016

(51) Int. Cl. A63F 13/53; A63F 13/25; A63F 13/803; A63F 13/90; A63F 13/52; A63F 13/213; A63F 13/46; A63F 13/30; A63F 13/79

(52) U.S. Cl. CPC A63F 13/53; A63F 13/25; A63F 13/803; A63F 13/90; A63F 13/79; A63F 13/213; A63F 13/46; A63F 13/30; A63F 13/52

(57) ABSTRACT

Apparatus for the collective playing of a multi-player computer game at a single location comprising a plurality of player stations and a game information display, in which each player station comprises a primary computer processor for running a computer game program, one or more physical player interfaces for receiving manual player inputs, and a game play display screen for displaying visual graphics for a player to base player inputs upon, in which said plurality of primary computer processors are connected together in a network, and each comprises a game data sending program which sends game data over said network when the respective primary computer processor runs said computer game program, in which said game information display comprises a secondary computer processor for running a display program, which secondary computer processor is connected to said network and comprises a game data receiving program for receiving game data sent by said game data sending programs, and in which when said secondary computer processor runs said display program it generates visual game information presentations and displays them on said game information display, said visual game information presentations being determined in at least one graphical characteristic by game data received by said game data receiving program.

The present invention relates to a multi-player computer game apparatus with a game information display, for use particularly, but not exclusively, as an arcade car racing game.

Multi-player arcade car racing games are well known. They commonly comprise a plurality of player cabinets which define a player environment, and which comprise computer processors for running the computer game program. The computer processors of each cabinet are networked together to collectively establish multi-player races for a plurality of players to take part in.

Commonly the cabinets are provided with a PC which runs a known operating system which has loaded on it a shell program and a game program. A shell program is the industry term for the background software which supports the game program, as well as other programs such as diagnostics, test routines and updates, as well as programs which control the various pieces of hardware on the cabinet such as the coin handling mechanisms, door switches, seat belts, speakers, screens and player inputs such as the pedals, steering wheel and gear shift mechanisms. Game programs sit underneath the shell program, and are the only things presented to the player. The shell program and the game program use appropriate directories on the PC to store their various files. Commonly with arcade games there is only one game program, but it is also possible for there to be two or more, in which case the shell program will provide a game menu system, and the user may access that to choose a game to play. Service engineers and operators will access the shell test routines by means of switches located behind a service door, which are not accessible to players.

One issue with arcade games is that it is not easy for a spectator to watch the game being played. This is particularly the case for modern arcade car racing games because they commonly have a substantial cabinet which can obscure the game play display screen from most angles. Further, it is not easy for a spectator of a multi-player car racing game to determine the relative positions in the race of each player.

In addition, when playing a multi-player arcade car racing game it is not easy for the players to see each other. This is because the substantial cabinets may obscure the competitors from one another, and also because when playing a car racing game a player needs to concentrate on the game play display screen. A player can only really see their competitors in the form of their cars in the visual display of the race.

In addition, multi-player arcade car racing games require a plurality of players to maximise the playability of the game for the players. If some of the cabinets are unoccupied the game is less enjoyable because there are fewer human competitors for the players.

Further, if there are more players than cabinets and a competition has to be organised to determine the best player, a tournament comprising a number of races must be organised. This can be time consuming and inconvenient to do manually, and as a result may not be attempted.

The present invention is intended to overcome some of the above described problems.

Therefore, according to the present invention apparatus for the collective playing of a multi-player computer game at a single location comprises a plurality of player stations and a game information display, in which each player station comprises a primary computer processor for running a computer game program, one or more physical player interfaces for receiving manual player inputs, and a game play display screen for displaying visual graphics for a player to base player inputs upon, in which said plurality of primary computer processors are connected together in a network, and each comprises a game data sending program which sends game data over said network when the respective primary computer processor runs said computer game program, in which said game information display comprises a secondary computer processor for running a display program, which secondary computer processor is connected to said network and comprises a game data receiving program for receiving game data sent by said game data sending programs, and in which when said secondary computer processor runs said display program it generates visual game information presentations and displays them on said game information display, said visual game information presentations being determined in at least one graphical characteristic by game data received by said game data receiving program.

Therefore, in its simplest form the present invention provides a multi-player computer game with a game information display which displays visual game information presentations which are tailored in at least one respect by data from the game being played. This game data could be the position of player in a car race, and the presentation could be an image or animation showing them moving into that position. It could also be game data relevant to any other kind of computer game, such as a move performed by a player in a fighting game, in which case the presentation could show them performing that move. The presentations could also relate to scheduled time based events in the game as opposed to player inputs, such as the start of a race, or the end of a fight for example. As such, a spectator can be shown presentations which inform them of events which have occurred in the playing of the game. These presentations are not intended for the players, as they would be in conflict with the live game play visuals presented on the game play display screens, and instead are intended to increase the enjoyment for spectators.

The term “primary computer processor” refers to any CPU or PC which can run computer game programs. Typically this will be a PC running a Microsoft Windows (RTM) operating system. This can be something which is capable of running the computer game program independently, or it can be something which is only capable of running the computer game program fully when connected to a computer network. In such an arrangement some or all of the running of the computer game program can be performed by a network server. As such, the term “primary computer processor” is intended to include any such known arrangement. The term “secondary computer processor” also refers to any CPU or PC which can run display programs and the like. Once again, this can be something which is independent, or it can be something with functions which are dispersed over a computer network. Again, the term “secondary computer processor” is intended to cover any such known arrangements.

In terms of the location of what would be known in the industry as the shell program and the game program, full versions of these can be loaded onto each primary computer processor, or their functions can be dispersed over the network. In particular, some aspects of the shell program would be hosted on a primary computer processor such as sub-programs which control a coin mechanism associated with a player station, while others could be hosted on the secondary computer processor, such as the display program, which would be considered part of a shell program rather than a game program.

Therefore, the various computer hardware and software which facilitates the functions of the present invention can be structured like known systems, and can be implemented by the skilled person using their common general knowledge, as well as their specific knowledge of the prior art in this area. As such, the specific software structure utilised will not be further described here in great detail, as it does not form a part of the present invention. Instead more emphasis is placed on the technical functions which are achieved when the various programs are run by the various computer processors.

Preferably when the computer game programs are run on the primary computer processors they can establish a competition for the plurality of players to take part in, and a graphical representative for each player taking part. The competition can comprise a plurality of potential in-game events involving at least one player, the occurrence of which can be determined by player inputs during the running of the computer game programs. Each primary computer processor can comprise a primary database of the in-game events and when the computer game program is run on each primary computer processor it can identify the occurrence of the in-game events by reference to the primary database, and prompt the associated game data sending program to send an event message to the secondary computer processor over the network, which event messages can comprise data indicating the in-game event identified and the identity of the player involved. The secondary computer processor can comprise a secondary database of template presentations each comprising at least one graphical representative enacting one of the in-game events. When the secondary computer processor runs the game data receiving program it can receive the event messages from the primary computer processor and prompt the display program to generate a visual game information presentation by selecting a template presentation from the secondary database according to the in-game event identified in the event message, and by setting at least one graphical characteristic of the graphical representative in the template presentation according to the identity of the player given in the event message. The display program can then display the generated visual game information presentation on the game information display after the in-game event has occurred.

Therefore, when an in-game event occurs, such as one player crashing their car independently, the primary computer processor of their player station sends an event message about it to the secondary computer processor, and it generates a bespoke visual game information presentation which relates to that specific event. The presentation can be a replay of the graphics which were presented on the game play display screen of the player in question when the in-game event occurred. However, preferably the presentation can be a representation of the in-game event presented from a spectator angle which is different to the graphics which were presented on the game play display screen of the player in question. This is more satisfying to observe. The presentation can be very detailed and comprise location and in-game event specific information, so it has the appearance of a graphical film of the event similar to as if the event had been captured on a television camera. Computer programs which are capable of generating such presentations from event data gathered during the playing of the game are known. However, as an alternative the presentation can be more abstract, for example a cartoon-like presentation which comprises a highly stylized graphical representative enacting the in-game event in a comical manner. The range of different styles of presentation is very wide, and the skilled person implementing the present invention can choose one to suit their preferences. The visual game information presentations can be static images, or they can be animations.

What is relevant is that at least one graphical characteristic of the graphical representative in the visual game information presentation is set, so it visually relates to the player in question. In the case of a car racing game the graphical characteristic can be the colour of the car. However, it will be appreciated that the at least one graphical characteristic can be a wide range of different graphical characteristics which each identify the graphical representative as one in particular. In the case of a car racing game this could include the type of car, size of car, the surface patterning or decoration, or even damage applied to the car. The graphical representative can also be more than just a character or a device, for example if could be a racing car and a graphical logo name written above it. In such a case graphical characteristics which can be set could include the name itself, the fonts used, the colour or colours of the name and so on. It could also include a captured image of the player, as described in further detail below.

In a preferred construction the competition can comprise a plurality of potential multi-player in-game events comprising parts played by a plurality of players, the occurrence of which can be determined by inputs from a plurality of players during the running of the computer game programs. When each of the primary computer processors runs the computer game program it can communicate with each other primary computer processor over the network so all the primary computer processors can collectively establish the competition for the plurality of players to take part in. Each of the primary databases can comprise the multi-player in-game events, and when the computer game program is run on each primary computer processor it can identify the occurrence of the multi-player in-game events its associated player is involved in by reference to the primary database, as well as a part played in the multi-player in-game event by its associated player. It can then prompt the associated game data sending program to send a multi-player event message to the secondary computer processor over the network, which multi-player event messages can comprise data indicating the multi-player in-game event identified, the identity of the associated player involved and the part played in the multi-player in-game event by that player. The secondary database can comprise template multi-player presentations comprising a plurality of graphical representatives enacting the respective parts played in one of the multi-player in-game events. When the game data receiving program receives a multi-player event message from a primary computer processor it can prompt the display program to generate a visual game information presentation by selecting a template multi-player presentation from the secondary database according to the multi-player in-game event identified in the multi-player event message, and by setting at least one graphical characteristic of one graphical representative in the template multi-player presentation according to the identity of the player and the part they played in the multi-player in-game event given in the multi-player event message. The display program can then display the generated visual game information presentation on the game information display after the multi-player in-game event has occurred.

With this construction some of the visual game information presentations feature two or more players, which makes them more interesting for the spectator and expands on the number of things which can be animated. For example, in a car racing game a multi-player in-game event could be an overtaking maneuver where one player overtakes another to take their position in the race. The primary computer processors of the players involved identify this and send multi-player event messages to the secondary computer processor so it can generate an appropriate visual game information presentation of the event, in the manner described above. Both primary computer processors involved could do this simultaneously, for example one sending a multi-player event message indicating that one player has overtaken another, while the other can send a multi-player event message indicating that one player has been overtaken by another. Alternatively, the primary computer processors in question can collectively send one such multi-player event message (in the manner of a game program communicating with a shell program). The manner in which such data messages can be controlled in a network will be known to the skilled person who can implement the technical features being explained using their skills and knowledge.

As with presentations featuring only one player, those featuring two or more can be a replay of the graphics which were presented on the game play display screen of one of the players involved. However, preferably they can be a representation of the multi-player in-game event presented from a spectator angle. Again this can be very detailed and comprise location and in-game event specific information, so it has the appearance of a graphical film of the event similar to as if the event had been captured on a television camera. Or, it can be more abstract, for example a cartoon-like presentation which comprises highly stylized graphical representatives enacting the multi-player in-game event. The graphical characteristic of the graphical representatives which is set can be like those in presentations featuring one player, such as the colours and types of the cars in question, or elements of additional logo or name graphics.

The plurality of player stations can each comprise a cabinet and a player environment. The primary computer processor can be housed inside the cabinet, and the cabinet can support the one or more physical player interfaces and the game play display screen at positions suitable for a pre-determined size of player occupying the player environment. The game information display can comprises a game information display screen or screens mounted on the apparatus at a position distant from the player environment such that a spectator outside of a player environment can have an unobstructed view thereof. This could include mounting the display screen or screens at the side of the apparatus, above the player stations, or on the rear side of the apparatus to the player stations. The location of the display screen or screens could be chosen to best suit a particular location.

The apparatus of the invention can comprise a single game information display screen, which could be large so as to be readily viewable from a large area, or it can comprise a plurality of game information display screens. In particular, in a preferred embodiment each cabinet can comprise a game information display screen mounted above the player environment. This is advantageous because a single design of cabinet can be manufactured, which can be combined with any number of other cabinets to facilitate the present invention.

In such an arrangement, when the secondary computer processor runs the display program it can display generated visual game information presentations on each of the plurality of game information display screens simultaneously. However, in an alternative embodiment when the secondary computer processor runs the display program it can display generated visual game information presentations on the game information display screens of the player stations of the player or players involved. With this construction spectators can be treated to presentations specific to particular players above where they are situated.

To facilitate this better there can be a plurality of secondary computer processors, each associated with one game information display screen, which are connected to the same network as the primary computer processors. As such, they can act independently of one another, or collectively.

Preferably when the game data receiving program receives an additional event message or multi-player event message from a primary computer processor relating to an additional in-game event or multi-player in-game event while the display program is generating or displaying a visual game information presentation relating to an initial event message or multiplayer event message relating to an initial in-game event or multi-player in-game event, the game data receiving program can prompt the display program to generate and display an additional visual game information presentation relating to the additional event message or multi-player event message. This is obviously easy to do if each secondary computer processor is associated with one game information display, as they can all act independently of one another.

With this arrangement the various game information display screens can display visual game information presentations simultaneously relating to different in-game events. For example, if two players crash into one another the game information display screens above them can show a visual game information presentation about this, while at the same time other game information display screens above other player can show visual game information presentations about an overtaking maneuver they were involved in. As such, a dynamic and constantly changing set of simultaneous presentations can be displayed for spectators, giving them a multi-layered appreciation of the events of the competition.

The cabinets can be of the type at which a player stands. Such constructions are preferred for fighting game types for example. However, in a preferred construction the cabinet can comprise a seat, the one or more physical player interfaces can be arranged around the seat and the game play display screen can be arranged in front of the seat. This construction is preferred for car racing games.

In a preferred construction each player station can comprise a camera for filming a player using the player station, a live image capturing program, a live image sending program, and a primary live image display program. When a primary computer processor runs the computer game program it can prompt the live image capturing program to capture a live image of the associated player, and the live image sending program to send the live image over the network to the other primary computer processors. When a primary computer processor runs the computer game program it can prompt the primary live image display program to display received live images on the associated game play display screen.

This feature adds another dimension to the apparatus, because it allows for competitors to see each other's faces on their game play display screens. This introduces a level of inter-player communication which can enhance the game playing experience. For example, two players competing for a position in a race can gesture to each other using facial expressions.

This can allow players to distract one another as a deliberate game tactic, or to express their pleasure or disapproval to another player for their in-game actions.

In versions of the invention in which when the computer game programs are run on the primary computer processors they establish a competition for the plurality of players to take part in, the computer game programs can also communicate with each other over the network to collectively establish a live ranking of players taking part in the competition which is determined by each player's inputs during the running of the computer game programs. As such, when a primary computer processor runs the computer game program it can prompt the primary live image display program to display received live images on the associated game play display screen in a visual order of the live ranking of some or all of the players.

Therefore, each player can see the faces of some or all of the other players, ranked in a visual order. For example, in a car racing game the faces of the players can be presented in a column to one side of the game play display screen, in the order they are in in the race. Such a visual presentation can be enhanced to display the distances between the players in the race, by spacing the received live images accordingly.

Preferably the plurality of primary computer processors can collectively establish changes in the live ranking of players. When a primary computer processor runs the computer game program it can prompt the primary live image display program to display a visual representation of a change in the live ranking of players by animating the received live images on the associated game play display screen to move positions in the visual order.

The manner in which the change in the live ranking can be displayed can be an instant switch, or it can be a complex presentation. For example, when a player in a car race overtakes another player, the received live images can overlap to represent the players drawing alongside one another, or the received live images can be made to do other visually animated things such as the received live image of the overtaking player knocking the received live image of the overtaken player to one side. The manner in which such graphical presentations can be created is known.

In one version of the invention the secondary computer processor can comprise a secondary live image display program. When a primary computer processor runs the computer game program it can prompt the live image sending program to send the live image over the network to the secondary computer processor. When the secondary computer processor runs the secondary live image display program it can display received live images on the game information display.

Therefore, the captured live images of the players can also be employed for the benefit of spectators, who can see the faces of the players as they compete.

In versions of the invention in which the primary computer processors collectively establish a live ranking of players taking part in the competition, when the secondary computer processor runs the secondary live image display program it can display received live images on the game information display in a visual order of the live ranking of some or all of the players depicted.

Further, in versions of the invention in which the primary computer processors collectively establish changes in the live ranking of players, when the secondary computer processor runs the secondary live image display program it can display a visual representation of a change in the live ranking of players by animating the received live images on the game information display to move positions in the visual order.

In the same way as the live ranking and changes in it can be displayed in different ways on the game play display screens, the same kinds of presentations can be shown on the game information display. Therefore, spectators can also be treated to a live presentation of the various positions of the players in the competition, and how this changes over time.

In one embodiment of the invention the secondary computer processor comprises a tournament program for arranging a sequence of the competitions and a tertiary database of player identities. When the secondary computer processor runs the tournament program it can arrange an initial draw of player identities taken from the tertiary database comprising one or more of said competitions and then it can prompt the display program to generate visual game invites to players scheduled to take part each competition and to display the visual game invites on the game information display. When the secondary computer processor runs the tournament program it can record performance data of each player taking part in the one or more competitions, and store the recorded performance data in the tertiary database. After the initial draw is completed the tournament program can arrange further draws of player identities taken from the tertiary database according to their stored performance data, the further draws comprising further one or more of the competitions, and it can then prompt the display program to generate visual game invites to players scheduled to take part in each of the further one or more competitions and to display the visual game invites on the game information display.

Therefore, the apparatus of the invention can be made to establish and hold a tournament for a plurality of players, and it can use the game information display to invite them to their respective player stations. These features allow for a tournament between a plurality of players to be fully automated, but it also allows for players to be invited to play at the appropriate times. In terms of the way the tournament program arranges further draws, if the computer game program is a car racing game, these can be based on the finishing positions of the players in the initial or earlier draws. For example, if the apparatus comprises four player stations, and eight players enter a tournament, those who finish in the first and second places in the initial competitions, and have such data recorded in the tertiary database, can then be invited to race in a final round to determine the overall winner. Those who finished in third and fourth places in the initial competitions, and have such data recorded in the tertiary database, can be invited to race in a lower placings final. It will be appreciated that the tournament program can facilitate a more complex tournament, for example with the players being ranked by the number of overtakes or stunts they performed rather than by their race finishing position. Further, a more complex set of initial heats can be run in which each player competes a number of times to produce a complex ranking score, and then a set of further heats or finals can be run according to those ranking scores.

In one version of the invention some of the above described features can be combined. In particular, in versions of the invention in which each player station comprises a camera for filming a player using the player station, a live image capturing program which captures a live image of the associated player and a live image sending program which sends the live image over the network to the secondary computer processor, this can be combined with the secondary computer processor comprising a secondary database of template presentations each comprising at least one graphical representative enacting one of the in-game events, such that the template presentations can each comprise a section for a live image of a player, and when the secondary computer processor runs the display program to generate and display a visual game information presentation it can apply the live image corresponding to the identity of the player given in the event message in the section.

With this construction the visual game information presentations can be enhanced by having the faces of the player or players involved in the in-game event included. For example in a car racing game, these faces can be shown inside graphical representatives of the cars.

As described above, the computer game program can relate to any kind of game, including fighting games, strategy games, and so on. However, preferably when the primary computer processors run the computer game programs they can establish a simulated vehicle race for the plurality of players to take part in and a graphical vehicle representative for each player taking part. The plurality of potential in-game events involving at least one player can then comprise one or more of a vehicle crash, a near vehicle crash, a vehicle stunt, a vehicle jump, the completion of a lap of the vehicle race, the completion of the vehicle race, the taking of the lead of the vehicle race, the moving into last place in the vehicle race and so on. The plurality of multi-player in-game events comprising parts played by a plurality of players can then comprise one or more of an overtaking maneuver involving two vehicles, an overtaking maneuver involving more than two vehicles, multi-vehicle crash, a near multi-vehicle crash, a multi-vehicle stunt, a multi-vehicle jump and so on.

The invention can be performed in various ways, but one embodiment will now be described by way of example and with reference to the accompanying drawings, in which:

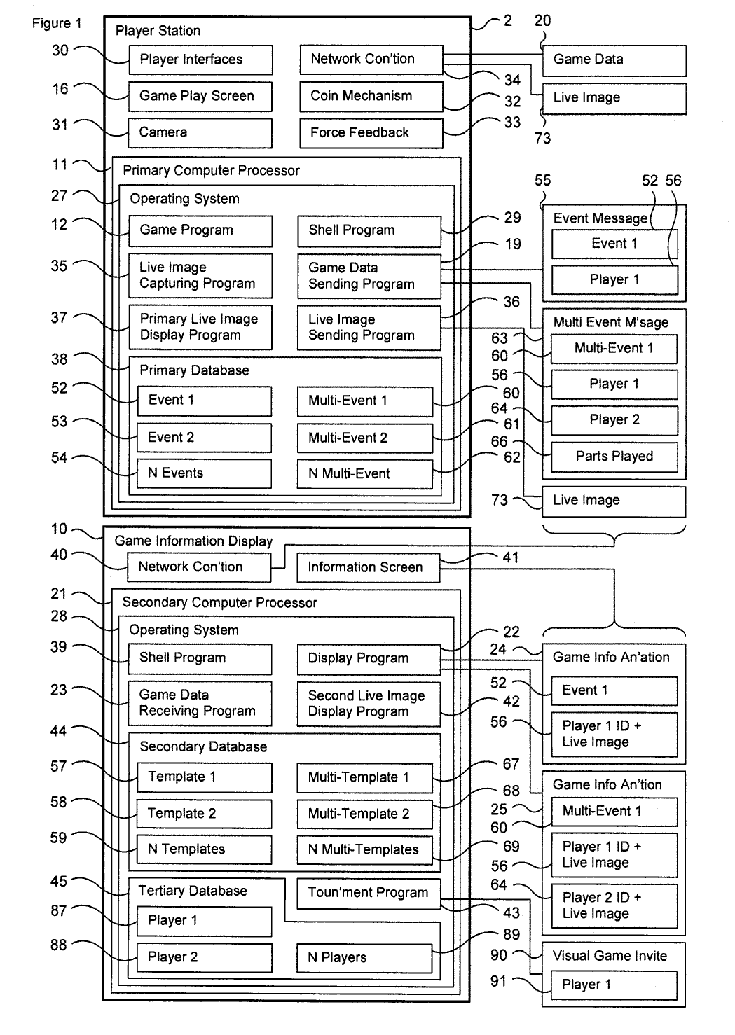

FIG. 1 is a diagrammatic view of player station and game information display parts of the apparatus of the present invention;

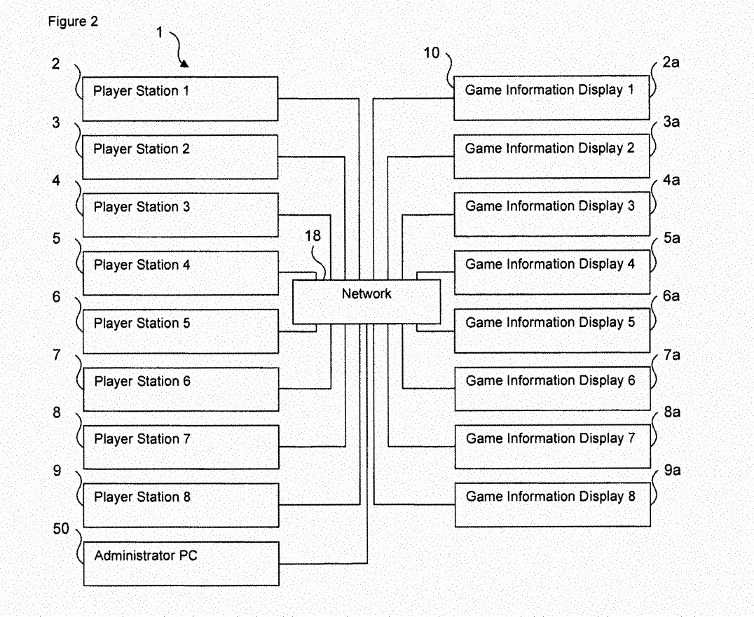

FIG. 2 is a diagrammatic view of the apparatus of the present invention;

FIG. 3 is a perspective view of a cabinet part of the apparatus of the present invention;

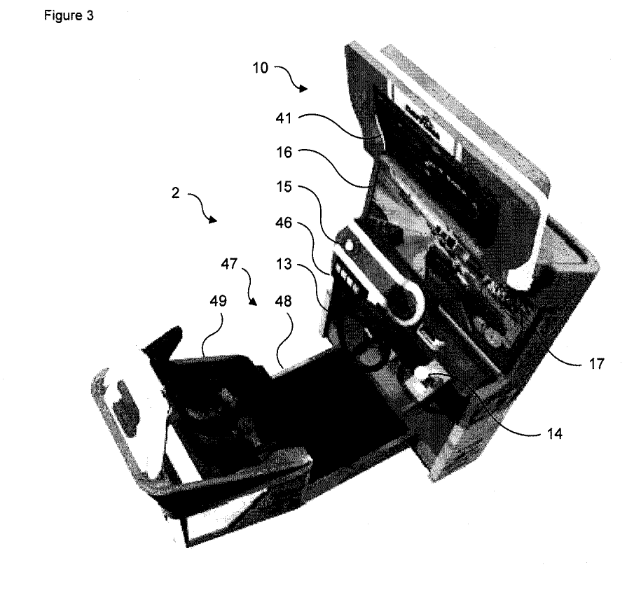

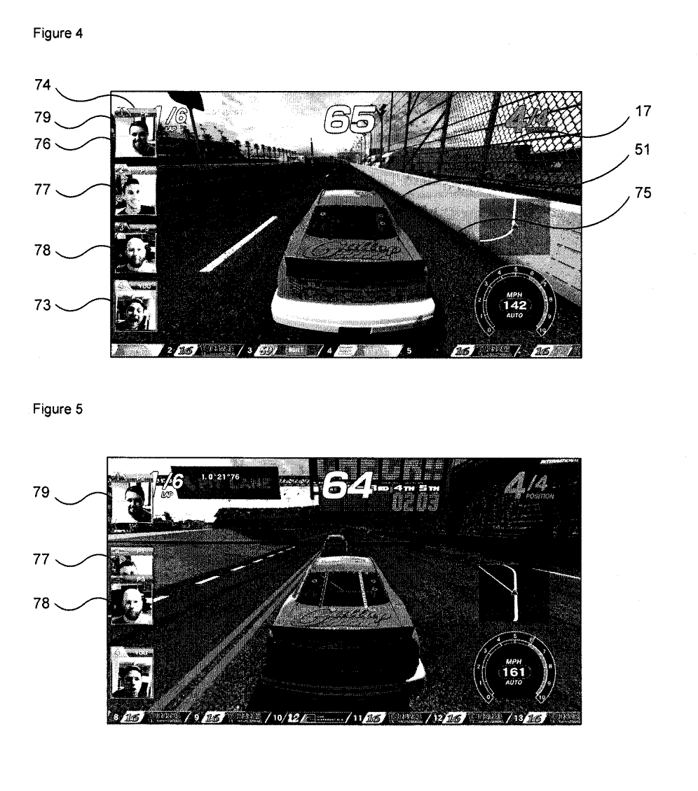

FIG. 4 is a first screen shot from a game play display screen part of the apparatus of the present invention;

FIG. 5 is a second screen shot from a game play display screen part of the apparatus of the present invention;

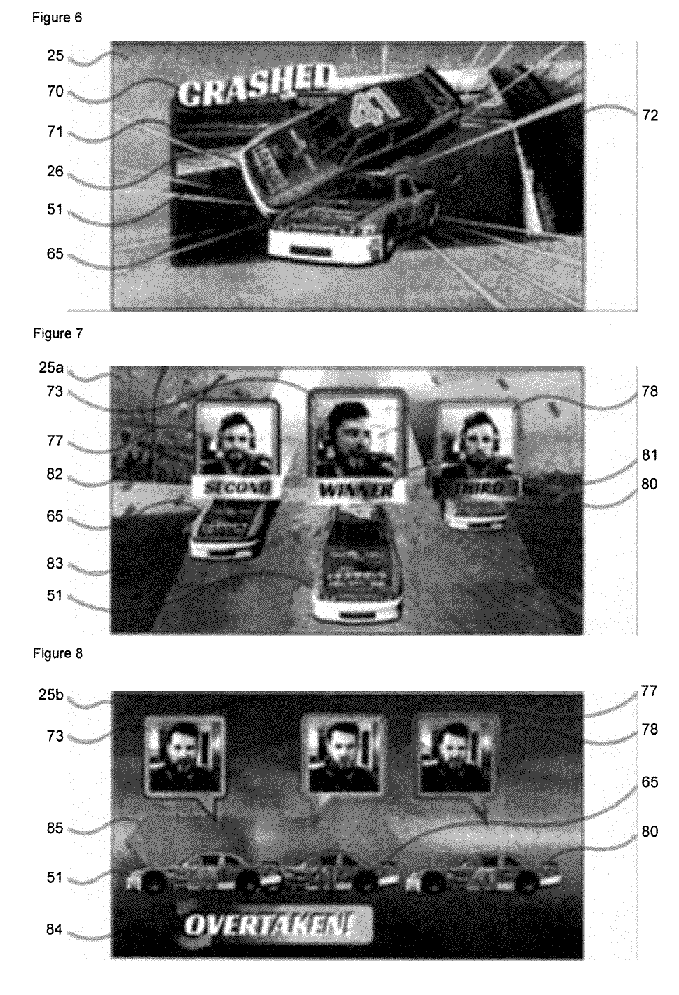

FIG. 6 is a first screen shot from a game information display screen part of the apparatus of the present invention;

FIG. 7 is a second screen shot from a game information display screen part of the apparatus of the present invention; and

FIG. 8 is a third screen shot from a game information display screen part of the apparatus of the present invention.

As shown in the Figures, apparatus 1 for the collective playing of a multi-player computer game at a single location comprises a plurality of player stations 2-9 and a game information display 10. Each player station 2-9 is the same, and comprises a primary computer processor 11 for running a computer game program 12, one or more physical player interfaces for receiving manual player inputs, in the form of steering wheel 13, gear shift 14, select button 15 and pedals (not visible), and a game play display screen 16 for displaying visual graphics 17 for a player to base player inputs upon. The plurality of primary computer processors 11 are connected together in a network 18, and each comprises a game data sending program 19 which sends game data 20 over the network 18 when the respective primary computer processor 11 runs the computer game program 12. The game information display 10 comprises a secondary computer processor 21 for running a display program 22, which secondary computer processor 21 is connected to the network 18 and comprises a game data receiving program 23 for receiving game data 20, 55, 63 sent by the game data sending programs 19, as described further below. When the secondary computer processor 21 runs the display program 22 it generates visual game information presentations 24, 25 and displays them on the game information display 10, the visual game information presentations 24, 25 being determined in at least one graphical characteristic 26 by game data 20, 55, 63 received by the game data receiving program 23.

It will be appreciated that the way in which the computer software and hardware of the apparatus 1 is described in the following description is simplistic, because it is directed to the technical effects which are achieved by the apparatus 1 when the various computer programs are run on the various computer processors, rather than the precise manner in which this is done, which can be in any of the known ways. Indeed, programming apparatus like that of the present invention is very much a matter for a skilled computer engineer, and it can be done in any number of different ways. For the invention to be carried out it is only necessary that the described technical effects are achieved.

As such, in this description reference is made to a number of different computer processors and computer programs, and to data sent between the various components of the apparatus 1. This nomenclature is for illustrative purposes only, and the various features of the invention may not actually be vested in physically separate computers, or be performed by separate computer programs installed thereon, and there could be a significant amount of overlap, in the known manner. For example, the primary computer processor 11 and the secondary computer processor 21 could be one and the same actual computer, or they could comprise computer sub-programs which combine to form the various computer programs described below.

As mentioned above, the term “primary computer processor” can refer to any CPU or PC which can run computer game programs. However, in apparatus 1 the primary computer processor 11 is a PC running a Microsoft Windows (RTM) operating system 27. The term “secondary computer processor” also refers to any CPU or PC which can run display programs and the like. However in apparatus 1 the secondary computer processor 21 is a Raspberry PI® with its own operating system 28.

The communication between the primary computer processor 11 and the secondary computer processor 21 is done via TCP/IP, which allows data to be sent efficiently from one application to the other, along with data blocks if required. The communications between the various computer programs described below are multifarious and include all the standard known kinds of communications for successfully running multi-player arcade games, and the structure and timing of these communications can be set by the skilled person using their common general knowledge.

In terms of the location of what would be known in the industry as the shell program, being distinct from a game program, this is dispersed over the various operating systems 27, 28. For example a first part of the shell program 29 is shown as being hosted on the primary computer processor 11. This is the part of the shell program which controls the various sub-programs which support the running of the computer game program 12. These include operating and controlling the hardware such as the player interfaces 30, which are the steering wheel 13, gear shift 14, select button 15, pedals (not visible) and the game play display screen 16, as well as operating and controlling the camera 31, coin mechanism 32, force feedback 33 and network connection 34 systems. The manner in which the shell program 29 operates and controls these hardware systems to perform their standard functions is as in known arcade game apparatus, or in the case of the camera 31 and network connection 34 as in known computing generally.

The shell program 29 also controls, or works alongside, the various software programs which also support the computer game program 12 and achieve the technical effects of the present invention. These include the game data sending program 19, the live image capturing program 35, the live image sending program 36 and the primary live image display program 37. It also controls, or works alongside, the primary database 38, and sub-programs which access it and produce results.

The shell program 29 also operates and controls other component hardware and software features of the player station 2 which are not shown as they are not relevant to the present invention, but which are nevertheless commonplace, such as power supplies, audio and speakers, lighting, test routines, performance, analytics and diagnostic functions, updates, administrator access and so forth.

Meanwhile, a second part of the shell program 39 is shown as being hosted on the secondary computer processor 21. This is the part of the shell program which controls the various sub-programs which support the running of the game information display 10. These include operating and controlling the hardware such as network connection 40 and game information display screen 41. The manner in which the shell program 39 operates and controls these hardware systems to perform their standard functions is as in computing generally.

The shell program 39 also controls, or works alongside, the various software programs which achieve the technical effects of the present invention. These include the display program 22, the game data receiving program 23, the secondary live image display program 42 and the tournament program 43. It also controls, or works alongside, the secondary database 44 and tertiary database 45, and sub-programs which access them and produce results. The shell program 39 also operates and controls other component hardware and software features of the game information display 10 which are not shown as they are not relevant to the present invention, but which are nevertheless commonplace for computerised displays, such as power supplies, audio and speakers, lighting, test routines, performance, analytics and diagnostic functions, updates, administrator access and so forth.

Referring to FIG. 3, this shows player station 2, which is the same as the other player stations 3-9. It comprises a cabinet 46 which defines a player environment 47. The primary computer processor 11 is physically housed inside the cabinet 46, and the cabinet 46 supports the physical player interfaces including the steering wheel 13, gear shift 14, select button 15, pedals (not visible) and the game play display screen 16. It also comprises a floor 48 and an adjustable seat 49 mounted thereon, for the player to be seated in when playing the computer game program 12. When a player is seated in the seat 49 the physical player interfaces are arranged in the appropriate positions for the player to use them, and in particular the game play display screen 16 is directly in front of them. The cabinet 46 also supports the camera 31 (not visible in FIG. 3) alongside the game play display screen 16, so it can capture an image of the player sat in the seat 49.

The cabinet also supports a number of other hardware components which are not relevant to the present invention, such as a coin mechanism 32 (which is not actually shown in

FIG. 3 as it is an optional component), lighting, force feedback mechanisms and advertising or decoration panels. These are all known in the art.

As shown in FIG. 3 the cabinet 46 also supports the game information display 10, in the form of game information display screen 41 arranged above the player environment 47. As such, the game information display 10 is distant from the player environment 47 such that a spectator outside of the player environment 47 can have an unobstructed view thereof. In particular, spectators watching from behind the cabinet 46 can readily see the game information display screen 41.

It will be appreciated that as each player station 2-9 is the same, each one has its own game information display screen 41, and all eight collectively form the game information display 10 as a whole. Therefore, each player station 2-9 effectively has its own part of the game information display 10, and these parts are illustrated in FIG. 2 as game information display parts 1-8 2a-9a. As the player stations 2-9 are each connected to their respective game information display parts 2a-9a via the network 18, and each player station 2-9 is connected to every other player station 2-9 via the network 18, the basic topology of apparatus 1 is as shown in FIG. 2. It will be appreciated that a computer network can be manifested in various different ways, for example it can comprise a distinct computer server with any number of client units attached to it, or it can simply be vested in PCs connected together which exchange data and respond to requests from each other. That is the case with network 18, which is not a physically separate computer server, but a hierarchy of data exchanges and requests. However, the apparatus 1 does comprise a discreet administrator PC 50, which allows an administrator to control the whole apparatus 1 in various ways. This can include organizing tournaments, as described further below, but it can also comprise standard administrative tasks like running tests, diagnostics and updates to the system.

As referred to in more detail below, when the computer game programs 12 are run on the primary computer processors 11 of each player station 2-9 they communicate with each other over the network 18 to collectively establish a simulated car race competition for the plurality of players to take part in, and a graphical vehicle representative 51 for each player taking part. The primary computer processors 11 establish such a competition over the network 18 in the known way. The game data sending programs 19 send game data 20 to each other via their network connections 34. In terms of the graphical vehicle representative 51 for each player, this is selected by the player during a game set-up stage before the game play begins, in the known way. The players are presented with a selection of vehicle types and colours on the game play display screen 16, and they choose which to use by entering selections using the steering wheel 13 and the select button 15 or pedals (not visible). They can also enter their name in this way so it is associated with their play, or their name can be entered into the competition by an administrator using the administrator PC 50, again in the known way.

The simulated car race competition comprises a plurality of potential in-game events involving one player, the occurrence of which is determined by player inputs during the running of the computer game program 12. These potential in-game events are occurrences which the coding of the computer game program 12 allows to happen within a player choice driven time-based narrative. For example, in the context of a car racing game, the race begins at a certain time, and is either run over a given time period, or over a given distance which can take any amount of time to complete, and within that time the user can make inputs with affect what happens in the narrative. For instance they can make inputs which result in their car successfully negotiating a bend, or they can make inputs which result in their car crashing at a bend. The player inputs are processed according to any number of complex parameters, and the results returned in an on-going sequence, to move the narrative forwards. All of this is known. Of relevance to the present invention are the particular definable in-game events in the context of such a narrative which trigger the generation of a visual game information presentation 24 or 25. In this example embodiment of the invention these in-game events involving one player are a crash, the completion of a lap of the race, the completion of the whole race, the taking of the lead of the race and the moving into last place of the race.

The primary database 38 contains these definable events, which are illustrated as first and second events 52 and 53, and n number of further events 54. This illustrates how there can be any number of these in-game events, as defined by the software engineer who programs the computer game program 12. When the computer game program 12 is run on the primary computer processor 11 it identifies the occurrence of these in-game events 52-54 by reference to the primary database 38, and when it does so it prompts the associated game data sending program 19 to send an event message 55 to the secondary computer processor 21 over the network 18, which event message comprises at least data indicating the in-game event identified and the identity of the player involved. FIG. 1 illustrates such an event message 55, and in this illustrative example it contains data which identifies first in-game event 52, and player ID 56. The player ID 56 is details of the graphical vehicle representative 51 which the player using player station 2 previously chose during the game set-up stage.

The secondary database 44 comprises template presentations 57-59 each comprising at least one blank graphical representative enacting one of the in-game events 52-54. These template presentations are illustrated as first and second template presentations 57 and 58, and n number of further template presentations 59. Each one of these template presentations 57-59 is associated with the corresponding in-game event 52-54. When the game data receiving program 23 is run on the secondary computer processor 21 it receives and processes the event message 55 and identifies the first in-game event 52 and the payer ID 56 from the data it contains. It then prompts the display program 22 to generate a visual game information presentation 24 by selecting the appropriate template presentation from the secondary database 44 according to the in-game event 52 identified, namely first template presentation 57, and by setting a graphical characteristic 26 of the graphical representative 51 in the template presentation 57 according to the player ID 56, namely the type and colour of the vehicle they chose.

The display program 22 then displays the generated visual game information presentation 24 on the game information display screen 41 after the in-game event 1 has occurred. Therefore, if the first in-game event 52 is a vehicle crash, the first template presentation 57 shows a graphical visualization of a vehicle crash, and the graphical vehicle representative 51 shown in it is that the player involved chose. As such, spectators watching a multi-player game involving a plurality of the player stations 2-9 are informed that one player has crashed independently when the visual game information presentation telling them so is displayed on the game information display screen 41 above where they are sitting.

The simulated car race competition also comprises a plurality of potential multi-player in-game events comprising parts played by a plurality of players, the occurrence of which are determined by inputs from a plurality of players during the running of the computer game programs 12. These potential multi-player in-game events are occurrences which the coding of the computer game program 12 allows to happen within the multi-player choice driven time-based narrative. This time the multi-player in-game events occur when the narratives being generated by two or more players overlap with one another. For example, two players can make inputs which result in their cars crashing into one another. In this case the definable multi-player in-game events comprising parts played by a plurality of players which trigger the generation of a visual game information presentation 25 are an overtaking maneuver involving two or more vehicles, a crash involving two or more vehicles and the completion of the race by the top three players.

The primary database 38 in each player station 2-9 contains these definable multi-player events, which are illustrated in FIG. 1 as first and second multi-player events 60 and 61, and n further multi-player events 62. This illustrates how there can be any number of these multi-player in-game events, as defined by the software engineer who programs the computer game program 12. When the computer game programs 12 are run on the primary computer processors 11 of each participating player station 2-9, they each identify the occurrence of these multi-player in-game events 60-62 that their associated players are involved in by reference to the primary databases 38. They also each identify the part played in the multi-player in-game event 60-62 by their associated player, if relevant, for example if they over took another player or were overtaken. At the same time, because the primary computer processors 11 are collectively establishing the competitive multi-player car racing competition, and exchanging a great deal of game data 20 over the network 18 in order to do this, when the computer game program 12 is run on each primary computer processor 11 it also identifies the identity of the other player, or players, involved in the identified multi-player in-game event, as that data is available to it.

Once the various parameters of the multi-player in-game event have been identified, the computer game programs 12 then prompt the associated game data sending programs 19 to send multi-player event messages 63 to their secondary computer processor 21 (that mounted in the same cabinet 46) over the network 18. These multi-player event messages 63 comprise at least data indicating the multi-player in-game event identified, the identity of the players involved and the parts played in the multi-player in-game event by the players involved. FIG. 1 illustrates such a multi-player in-game event message 63, and in this illustrative example it contains data which identifies first multi-player event 60, first player ID 56 (which are the details of the graphical vehicle representative 51 which the player using player station 2 previously chose during the game set-up stage), second player ID 64 (which are the details of the graphical vehicle representative 65 which that particular player previously chose during the game set-up stage), and the parts played in the multi-player in-game event 66.

Each secondary database 44 comprises template multi-player presentations 67-69 each comprising a plurality of blank graphical representatives enacting the respective parts played in one of the multi-player in-game events 60-62. These template multi-player presentations are illustrated as first and second template multi-player presentations 67 and 68, and n further template multi-player presentations 69. Each one of these template presentations 67-69 is associated with the corresponding multi-player in game event 60-62. When the game data receiving program 23 is run on the secondary computer processor 21 it receives and processes the multi-player event message 63 and identifies the first multi-player in-game event 60, the player IDs 56 and 64, and the respective parts they played 66 in the first multi-player in-game event 60 from the data the multi-player event message 63 contains. It then prompts the display program 22 to generate a visual game information presentation 25 by selecting the appropriate template multi-player presentation from the secondary database 44 according to the multi-player in-game event 60 identified, namely the first multi-player template presentation 67, and by then setting the graphical characteristics 26 of the appropriate graphical representatives 51 and 65 in the template multi-player presentation 67 according to the player IDs 56 and 64 and the respective parts they played in the multi-player in-game event 60, namely the type and colour of the vehicles they both chose, and the positions they need to be in the presentation.

The display program 22 then displays the generated visual game information presentation 25 on the game information display screen 41 after the in-game event 1 has occurred. Therefore, if the first multi-player in-game event 60 is a two vehicle crash, the first template multi-player presentation 67 shows a graphical visualization of a vehicle crash, and the graphical vehicle representatives 51 and 65 shown are those the players involved chose during the game set-up stage. As such, spectators watching a multi-player game involving a plurality of the player stations 2-9 are informed that two of the players have crashed into each other when the visual game information presentation 25 telling them so is displayed on the game information display screens 41 above where the two players are sitting.

A screen shot from such a generated visual game information presentation 25 is shown in FIG. 6. This shows a graphical visualization of two race cars crashing into one another. In this case a first graphical vehicle representative 51 is illustrated as crashing into the back of a second graphical vehicle representative 65. The at least one graphical characteristic 26 of visual game information presentation 25 which is set by the display program 22 is the type of vehicle and its livery which is associated with the first player, as determined by the player ID data 56 in the multi-player event message 63, which is applied to the first graphical vehicle representative 51. However, there are three other graphical characteristics of visual game information presentation 25 which are set by the display program 22 according to data contained in the multi-player event message 63, namely the type of vehicle and its livery which is associated with the second player, which is applied to the second graphical vehicle representative 65, the relative position of the first graphical vehicle representative 51 and the relative position of the second graphical vehicle representative 65. The visual game information presentation 25 also comprises a number of other visual elements which inform spectators of the nature of the multi-player in-game event, namely the word CRASHED 70, a background location image 71 and other visual elements 72 which increase the dramatic visual effect.

It will be appreciated from the above that the visual game information presentation 25 as shown in FIG. 6 will only be shown on the game information display screens 41 of the cabinets 46 of the two players involved. At the same time as it is being shown, other visual game information presentations 24, 25, relating to other single or multi-player events, can be generated and displayed by other display programs 22. As such, the game information display 10 as a whole can show multiple visual game information presentations 24, 25 simultaneously. As such, a dynamic and constantly changing set of simultaneous presentations can be displayed for spectators, giving them a multi-layered appreciation of the events of the competition.

The above described visual game information presentations 24, 25 represent only a first part of the capabilities of the apparatus 1. In particular, the cameras 31 and their associated software bring the player's faces into the game play, and into the visual game information presentations 24, 25.

When the computer game program 12 is run on the primary computer processor 11 it prompts the live image capturing program 35 to capture a live image 73 of the player using the player station 2, who is sitting in the seat 49 in front of the camera 31. The live image capturing program 35 comprises a number of sub-programs which include facial recognition sub-programs and cropping sub-programs. These identify the player's face in the live images which are captured, and crop the footage so the face appears in the centre. Such software is known with digital cameras. The live image sending program 36 then sends the captured live image 73 over the network 18 to the other primary computer processors 11.

At the same time as the captured live image 73 is being transmitted to the network 18, all the other live images captured by the other player stations 3-9 are being received. When the primary computer processor 11 runs the computer game program 12 it prompts the primary live image display program 37 to display those received live images 74 on the associated game play display screen 16.

Referring to FIG. 4, this shows a screen shot from the game play display screen 16 during the playing of the computer game program 12 by four players. In particular, it shows graphical vehicle representative 51 in the centre of the screen 16, which is the vehicle type and livery chosen by the player in the game set-up stage, travelling along a race track location 75. However, on the left hand side are shown the received live images 74, in the form of first, second and third live images 76, 77 and 78, as well as live image 73 of the player on player station 2. As can be seen from FIG. 4, the live images 73 and 76 to 78 clearly show the faces of the players competing in the race car competition.

As described above, when the computer game programs 12 are run on the primary computer processors 11 they collectively establish a race car competition for the plurality of players to take part in. As a part of this activity the computer game programs 12 communicate with each other over the network 18 to collectively establish a live ranking of players taking part in the race car competition, which is determined by each player's inputs during the running of the computer game programs 12. As such, when the computer game program 12 is run on the primary computer processor 11 it prompts the primary live image display program 37 to display the received live images 74 on the game play display screen 16 in a visual order of the live ranking of some or all of the players. As shown in FIG. 4, this is done in a column 79, with the leading player shown at the top and the last placed player at the bottom. In this case the screen shot shown in FIG. 4 relates to a race car competition with four players, and player 2 is in the lead, player 1 is second, player 3 is third and the player 73 using player station 2 is in last place.

As is clear from FIG. 4, this feature adds another dimension to the apparatus 1, because it allows for competitors to see each other's faces on their game play display screens 16. This introduces a level of inter-player communication which can enhance the game playing experience. For example, two players competing for a position in a race can gesture to each other using facial expressions. This can allow players to distract one another as a deliberate game tactic, or to express their pleasure or disapproval to another player for their in-game actions.

Further, when the computer game programs 12 are run on the primary computer processors 11 and they collectively establish the race car competition, they also collectively establish changes in the live ranking of players. Therefore, when the computer game program 12 is run on the primary computer processor 11 it prompts the primary live image display program 37 to display a visual representation of a change in the live ranking of players whenever there is such a change, by animating the received live images 73, 74 on the game play display screen 16 to move positions in the visual order.

FIG. 5 shows a screen shot from the game play display screen 16 during the playing of the computer game program 12 when there is such a change in the live ranking of the players. In particular, player 3 is overtaking player 1, and this is illustrated by the third live image 78 moving over the second live image 77. If player 3 completes the overtaking maneuver then the third live image 78 will move past the second live image 77 and into the second position in the column 79. If not, then the third live image 78 will move back into the third position in the column 79.

The captured live images 73 and 74 are also used to enhance the visual game information presentations 24, 25 for the benefit of spectators rather than players. In particular, when the computer game program 12 is run on the primary computer processor 11 it prompts the live image sending program 36 to send the capture live image 73 as well as the received live images 74 over the network 18 to the secondary computer processor 21. When the secondary live image display program 42 is run on the secondary computer processor 21 is displays the live images 73 and 74 on the game information display screen 41.

This can be done independently of any visual game information presentation 24, 25, and can simply be a presentation of the various received live images 73, 74. These can be shown independently of one another, for example the live image of each player can be shown on their respective game information display screen. Or, these images can be shown like they are in the screen shots shown in FIGS. 4 and 5, in an order of those competing, and with animated changes of position.

However, as an alternative, or in addition to this, it can be done as part of a visual game information presentation 25, such as those show in FIGS. 7 and 8. FIG. 7 shows a screen shot of a generated visual game information presentation 25a which is generated and displayed in the manner described in detail above, when the multi-player in-game event of the completion of the race by the top three players has occurred. The visual game information presentation 25a comprises three graphical vehicle representatives, which in this case are graphical vehicle representative 51 of the player using player station 2, graphical vehicle representative 65 of the player who finished second in the car race competition, and graphical vehicle representative 80 of the player who finished third. In each case, the primary graphical characteristic 26 which is set by the display program 22 is the type and livery of the graphical vehicle representatives 51, 65, 80 which the players chose in the game set-up stage. However, there is also the relative positions they are shown in. All of this data is taken from the multi-player event message 63. As before, the visual game information presentation 25a also comprises a number of other visual elements which inform spectators of the nature of the multi-player in-game event, namely the words 81, a background location image 82 and other visual elements 83 which increase the dramatic visual effect.

However, as will be appreciated from FIG. 7, the relevant captured live images are also included in this visual game information presentation 25a in the appropriate positions above the associated graphical vehicle representatives 51, 65 and 80. In this case the player using player station 2 has won the race, so live image 73 captured by camera 31 is shown in the centre of the visual game information presentation 25a. Players 1 and 3 using other of the player stations 3-9 have finished second and third, and their images 77 and 78 are shown in the relevant positions on the left and right of the winner. As the images are live the spectators can see the moving expressions of the three players on the game information display screens 41 above their respective seated positions. Although the multi-player event message 63 is described above as being a message which is sent from the primary computer processor 11 to the secondary computer processor 21 as a discreet event, it will be appreciated that this is simplistic and has just been done for explanatory purposes. In order to show the live images 73, 77 and 78 in the visual game information presentation 25a shown in FIG. 7, it is necessary for the multi-player event message 63 to effectively be an on-going data stream, so that the live images 73, 77 and 78 can be fed to the game information display screen 41 in this way. A computer engineer will be able to facilitate this functionality using their common general knowledge of the field.

FIG. 1 shows the visual game information presentations 24 and 25 as comprising data concerning the player ID as well as their live image. This is shown at 56 in visual game information presentation 24, and at 56 and 64 in visual game information presentation 25.

FIG. 8 shows yet another visual game information presentation 25b which is generated and displayed in the manner described in detail above, when the multi-player in-game event of an overtaking maneuver has occurred. The visual game information presentation 25b comprises three graphical vehicle representatives, which this time are side on views of the graphical vehicle representatives 51, 65 and 80, which are the same as those show in FIG. 7. Again, the primary graphical characteristic 26 which is set by the display program 22 is the type and livery of the graphical vehicle representatives 51, 65, 80 which the players chose in the game set-up stage. However, there is also the relative in-race positions they are shown in. Once again all of this data is taken from the multi-player event message 63. As before, the visual game information presentation 25b also comprises a number of other visual elements which inform spectators of the nature of the multi-player in-game event, namely the word OVERTAKEN 84 and other visual elements 85 which increase the dramatic visual effect.

However, as will be appreciated from FIG. 8, the relevant captured live images are also included in this visual game information presentation 25b in the appropriate positions above the associated graphical vehicle representatives 51, 65 and 80. In this case the player using player station 2 has overtaken player 1, so live image 73 captured by camera 31 is shown above graphical vehicle representative 51, and live image 77 is shown above graphical vehicle representative 65. Player 3 is next in the race, so their live image 78 is shown above graphical vehicle representative 80. As the images are live the spectators can see the moving expressions of the three players on the game information display screens 41 above their respective seated positions.

The computer game program 12 can be used by any number of players. A single player can use the player station 2 to play an entirely automated set of competitors, or just two players can use two player stations to compete against one another, and/or against some additional automated competitors. These kinds of arrangements are known. Therefore, the visual game information presentations will work regardless of how many competitors there are, although for the invention to be achieved there must be a plurality of player stations available, even if only one is used. If there are fewer competitors than a visual game information presentation is capable of involving, it will still be used, only with some positions left blank, or filled in with automated competitors. Therefore, while apparatus 1 is shown as comprising eight player stations, not all of them need be used for the invention to be achieved. For example, only four players are using apparatus 1 when the screen shots shown in FIGS. 4 and 5 take place.

Apparatus 1 comprises one further feature which utilises the game information display 10, namely the displaying of visual game invites 86 thereon during the running of a tournament. In FIG. 1 tournament program 43 is shown as being hosted on the secondary computer processor 21, but as mentioned several times above, this may be simplistic and some elements of the tournament program 43 may be hosted elsewhere. In particular, in apparatus 1 the administrator PC 50 is used to establish the tournament in terms of the names of the player entries, and optionally the name of the tournament. This can be done using a known computer program for entering player data and arranging it into a tournament involving a sequence of race car competitions. Therefore, the tournament program 43 and the tertiary database 45 may not be physically hosted and stored on one secondary computer processor 21, but for the purposes of their technical functionality they are shown there in this illustrative embodiment. At the very least the tournament program 43 forms a part of the shell program, not the game program.

When the secondary computer processor 21 runs the tournament program 43 it arranges an initial draw of player identities taken from the tertiary database 45 comprising one or more of the race car competitions described above. The player identity entries are illustrated as first and second players 87 and 88, and n number of further players 89. This illustrates how there can be any number of further players, as defined by the number entered by the users via the administrator PC 50. So, for example if there are 16 player entries in the tertiary database 45 the tournament program 43 can randomly select them into two initial eight player race car competitions. The tournament program 43 then prompts the display program 22 to generate visual game invites 90 to players scheduled to take part each race car competition and to display the visual game invites 90 on the game information display 10. In each case, the tournament program 43 on each secondary computer processor 21 generates a visual game invite 90 comprising the player ID 91 of the player selected to play on that player station 2, and it then displays it on the associated game information display screen 41. Therefore, all the players standing in front of the apparatus 1 are shown which players need to sit where for the first initial race car competition. Once that has been completed, the process is performed again and all the players standing in front of the apparatus 1 are shown which players need to sit where for the second initial race car competition.

When the secondary computer processor 21 runs the tournament program 43 it records performance data of each player taking part in the initial race car competitions, and stores that recorded performance data in the tertiary database 45 against the relevant player entry 87-89. This performance data can be the position they finished their respective initial race car competition.

After the initial draw is completed the tournament program 43 arranges further draws of player identities taken from the tertiary database 45 according to their stored performance data, the further draws comprising further one or more of the race car competitions. The further draws are an A final for the players who finished in the top four positions in the first and second initial race car competitions, and a B final for the players who finished in the bottom four positions in the first and second initial race car competitions. Once again, the tournament program 43 generates a visual game invite 90 comprising the player ID 91 of the player selected to play on that player station 2, and it then displays it on the associated game information display screen 41. Therefore, all the players standing in front of the apparatus 1 are shown which players need to sit where for the B final. Once that has been completed, the process is performed again and all the players standing in front of the apparatus 1 are shown which players need to sit where for the A final.

Therefore, the apparatus 1 establishes and holds a tournament for a plurality of players, and it uses the game information display 10 to invite them to their respective player stations. These features allow for a tournament between a plurality of players to fully automated, but it also allows for players to be invited to play at the appropriate times. It will be appreciated that the tournament program 43 can be configured to facilitate a more complex tournament, for example with the players being ranked by the number of overtakes or stunts they performed in their initial car race competition rather than by their race finishing position. Further, a more complex set of initial heats can be run in which each player competes a number of times to produce a complex ranking score, and then a set of further heats or finals are run according to those ranking scores. Tournaments of these structures are known, and computer software which can arrange them and facilitate them are also known. However, the technical feature the apparatus 1 introduces is the visual game invites 90 which direct players to their respective player stations 2-9 as and when they need to compete.

It is possible for the visual game invites 90 which are generated for the further race car competitions after the initial ones to include a static or animated part of the live images 73, 74 captured during the initial race car competitions. As such, not only are the players' names shown on the visual game invites 90, but their faces too. Once again, this is something the software engineer who codes the computer game program 12 can implement as they see fit.

The present invention can be altered without departing from the scope of claim 1. For example in one alternative embodiment (not shown) the apparatus can comprise a single game information display screen, which is mounted above a plurality of player stations. With this construction visual game information displays are shown which relate to the car race competition as a whole, rather than just to specific players arranged beneath it.

In other alternative embodiments (not shown) the computer game programs relate to other kinds of computer games, such as strategy games, fighting games and so on. In such embodiments the in-game events and multi-player in-game events relate to the competitions in question, as do the visual game information displays.

In other alternative embodiments (not shown) the various computer processors and programs are dispersed differently across the hardware of the apparatus. For example, in one alternative embodiment (not shown) the tournament program is hosted on the administrator PC.

In other alternative embodiments (not shown) instead of from template presentations as such, the visual game information presentations can be generated from other things. For example, in one alternative embodiment (not shown) they can be recordings of actual game play taken from the game play display screens. In another alternative embodiment (not shown) they can be generated from computer code provided by the primary computer processor.

Therefore, the present invention provides apparatus for the collective playing of a multi-player computer game which significantly improves the playing and watching experience by generating and displaying information about events occurring during in the competition, and the expressions on the faces of those playing when they do.

1. Apparatus for the collective playing of a multi-player computer game at a single location comprising a plurality of player stations and a game information display,
in which each player station comprises a primary computer processor for running a computer game program, one or more physical player interfaces for receiving manual player inputs, and a game play display screen for displaying visual graphics for a player to base player inputs upon,
in which said plurality of primary computer processors are connected together in a network, and each comprises a game data sending program which sends game data over said network when the respective primary computer processor runs said computer game program,
in which said game information display comprises a secondary computer processor for running a display program, which secondary computer processor is connected to said network and comprises a game data receiving program for receiving game data sent by said game data sending programs,
and in which when said secondary computer processor runs said display program it generates visual game information presentations and displays them on said game information display, said visual game information presentations being determined in at least one graphical characteristic by game data received by said game data receiving program.

2. Apparatus as claimed in claim 1 in which when said computer game programs are run on said primary computer processors they establish a competition for said plurality of players to take part in and a graphical representative for each player taking part,
in which said competition comprises a plurality of potential in-game events involving at least one player, the occurrence of which is determined by player inputs during the running of said computer game programs,
in which each primary computer processor comprises a primary database of said in-game events and when said computer game program is run on each primary computer processor it identifies the occurrence of said in-game events by reference to said primary database and prompts the associated game data sending program to send an event message to said secondary computer processor over said network, which event message comprises data indicating the in-game event identified and the identity of the player involved,
in which said secondary computer processor comprises a secondary database of template presentations each comprising at least one graphical representative enacting one of said in-game events,
in which when said secondary computer processor runs said game data receiving program it receives said event messages from said primary computer processors and prompts said display program to generate a visual game information presentation by selecting a template presentation from said secondary database according to the in-game event identified in said event message, and by setting at least one graphical characteristic of said graphical representative in said template presentation according to the identity of the player given in said event message, and in which said display program then displays the generated visual game information presentation on said game information display after said in-game event has occurred.

3. Apparatus as claimed in claim 2 in which said competition comprises a plurality of potential multi-player in-game events comprising parts played by a plurality of players, the occurrence of which is determined by inputs from a plurality of players during the running of said computer game programs,
in which when each of said primary computer processors runs said computer game program it communicates with each other primary computer processor over said network so all said primary computer processors collectively establish said competition for said plurality of players to take part in,
in which each of said primary databases comprises said multi-player in-game events, and when said computer game program is run on each primary computer processor it identifies the occurrence of said multi-player in-game events its associated player is involved in by reference to said primary database, as well as a part played in said multi-player in-game event by its associated player, and prompts the associated game data sending program to send a multi-player event message to said secondary computer processor over said network, which multi-player event messages comprises data indicating said multi-player in-game event identified, the identity of the associated player involved and the part played in said multi-player in-game event by said associated player involved,
in which said secondary database comprises template multi-player presentations comprising a plurality of graphical representatives enacting the respective parts played in one of said multi-player in-game events,
in which when said game data receiving program receives a multi-player event message from a primary computer processor it prompts said display program to generate a visual game information presentation by selecting a template multi-player presentation from said secondary database according to the multi-player in-game event identified in said multi-player event message, and by setting at least one graphical characteristic of one graphical representative in said template multi-player presentation according to the identity of the player and the part they played in said multi-player in-game event given in said multi-player event message, and in which said display program then displays the generated visual game information presentation on said game information display after said multi-player in-game event has occurred.

4. Apparatus as claimed in claim 1 in which said plurality of player stations each comprises a cabinet and a player environment, in which said primary computer processor is housed inside said cabinet, in which said cabinet supports said one or more physical player interfaces and said game play display screen at positions suitable for a pre-determined size of player occupying said player environment, and in which said game information display comprises a game information display screen or screens mounted on said apparatus at a position distant from said player environment such that a spectator outside of a player environment has an unobstructed view thereof.

5. Apparatus as claimed in claim 4 in which said apparatus comprises a plurality of game information display screens, and in which each cabinet comprises a game information display screen mounted above said player environment.

6. Apparatus as claimed in claim 3 in which said apparatus comprises a plurality of game information display screens, each of which is associated with a player station, and in which when said secondary computer processor runs said display program it displays generated visual game information presentations on each of said plurality of game information display screens simultaneously.

7. Apparatus as claimed in claim 3 in which said apparatus comprises a plurality of game information display screens, each of which is associated with a player station, and in which when said secondary computer processor runs said display program it displays generated visual game information presentations on the game information display screens of the player stations of the player or players involved.

8. Apparatus as claimed in claim 7 in which when said game data receiving program receives an additional event message or multi-player event message from a primary computer processor relating to an additional in-game event or multi-player in-game event while said display program is generating or displaying a visual game information presentation relating to an initial event message or multiplayer event message relating to an initial in-game event or multi-player in-game event, said game data receiving program prompts said display program to generate and display an additional visual game information presentation relating to said additional event message or multi-player event message.

9. Apparatus as claimed in claim 4 in which said cabinet comprises a seat, in which said one or more physical player interfaces are arranged around said seat, and in which said game play display screen is arranged in front of said seat.

10. Apparatus as claimed in claim 1 in which each player station comprises a camera for filming a player using said player station, a live image capturing program, a live image sending program, and a primary live image display program,
in which when a primary computer processor runs said computer game program it prompts said live image capturing program to capture a live image of the associated player, and said live image sending program to send said live image over said network to the other primary computer processors,
in which when a primary computer processor runs said computer game program it prompts said primary live image display program to display received live images on the associated game play display screen.

11. Apparatus as claimed in claim 10 in which when said computer game programs are run on said primary computer processors they establish a competition for said plurality of players to take part in,
in which when each of said primary computer processors runs said computer game program it communicates with each other primary computer processor over said network so all said primary computer processors collectively establish a live ranking of players taking part in said competition which is determined by each player's inputs during the running of said computer game programs,
in which when a primary computer processor runs said computer game program it prompts said primary live image display program to display received live images on the associated game play display screen in a visual order of said live ranking of some or all of said players.

12. Apparatus as claimed in claim 11 in which said plurality of primary computer processors collectively establish changes in said live ranking of players,
and in which when a primary computer processor runs said computer game program it prompts said primary live image display program to display a visual representation of a change in said live ranking of players by animating said received live images on the associated game play display screen to move positions in said visual order.

13. Apparatus as claimed in claim 10 in which said secondary computer processor comprises a secondary live image display program,
in which when a primary computer processor runs said computer game program it prompts said live image sending program to send said live image over said network to said secondary computer processor,
and in which when said secondary computer processor runs said secondary live image display program it displays received live images on the game information display.

14. Apparatus as claimed in claim 12 in which when said computer game programs are run on said primary computer processors they establish a competition for said plurality of players to take part in,
in which when each of said primary computer processors runs said computer game program it communicates with each other primary computer processor over said network so all said primary computer processors collectively establish a live ranking of players taking part in said competition which is determined by each player's inputs during the running of said computer game programs,
in which when said secondary computer processor runs said secondary live image display program it displays received live images on the game information display in a visual order of the live ranking of some or all of the players depicted.

15. Apparatus as claimed in claim 14 in which said plurality of primary computer processors collectively establish changes in said live ranking of players,
and in which when said secondary computer processor runs said secondary live image display program it displays a visual representation of a change in said live ranking of players by animating said received live images on the game information display to move positions in said visual order.

16. Apparatus as claimed in claim 2 in which said secondary computer processor comprises a tournament program for arranging a sequence of said competitions and a tertiary database of player identities,
in which when said secondary computer processor runs said tournament program it arranges an initial draw of player identities taken from said tertiary database comprising one or more of said competitions and then prompts said display program to generate visual game invites to players scheduled to take part each competition and to display said visual game invites on said game information display,
in which when said secondary computer processor runs said tournament program it records performance data of each player taking part in said one or more competitions, and stores said recorded performance data in said tertiary database,
in which after said initial draw is completed said tournament program arranges further draws of player identities taken from said tertiary database according to their stored performance data, said further draws comprising further one or more of said competitions, and then prompts said display program to generate visual game invites to players scheduled to take part in each of said further one or more competitions and to display said visual game invites on said game information display.

17. Apparatus as claimed in claim 2 in which each player station comprises a camera for filming a player using said player station, a live image capturing program and a live image sending program,
in which when a primary computer processor runs said computer game program it prompts said live image capturing program to capture a live image of the associated player, and said live image sending program to send said live image over said network to said secondary computer processor,
in which said template presentations each comprise a section for a live image of a player, and in which when said secondary computer processor runs said display program to generate and display a visual game information presentation it applies the live image corresponding to the identity of the player given in the event message in said section.

18. Apparatus as claimed in claim 3 in which said when said computer game programs are run on said primary computer processors they establish a simulated vehicle race for said plurality of players to take part in and a graphical vehicle for each player taking part,
in which said plurality of potential in-game events involving at least one player comprise one or more of a vehicle crash, a near vehicle crash, a vehicle stunt, a vehicle jump, the completion of a lap of said vehicle race, the completion of said vehicle race, the taking of the lead of said vehicle race, the moving into last place in said vehicle race,
and in which said plurality of multi-player in-game events comprising parts played by a plurality of players comprise one or more of an overtaking maneuver involving two vehicles, an overtaking maneuver involving more than two vehicles, multi-vehicle crash, a near multi-vehicle crash, a multi-vehicle stunt, a multi-vehicle jump.
